(19) United States
(12) Patent Application Publication
(10) Pub. No.: US 2025/0321843 A1
(43) Pub. Date: Oct. 16, 2025

(54) APPARATUS, METHOD, OPTIMUM ARRANGEMENT DETERMINATION APPARATUS, OPTIMUM ARRANGEMENT DETERMINATION METHOD AND RECORDING MEDIUM

(71) Applicant: NIPPON TELEGRAPH AND TELEPHONE CORPORATION, Tokyo (JP)

(72) Inventors: Ryutaro MATSUMURA, Tokyo (JP); Shigeaki HARADA, Tokyo (JP); Ryota NAKAMURA, Tokyo (JP); Kengo URATA, Tokyo (JP)

(21) Appl. No.: 18/868,060

(22) PCT Filed: Jun. 30, 2022
(86) PCT No.: PCT/JP2022/026408

§ 371 Date: Nov. 21, 2024

(51) Int. Cl. G06F 11/30; G06F 11/34

(52) U.S. Cl. CPC G06F 11/3062; G06F 11/3433

(57) ABSTRACT

An apparatus for determining an optimum arrangement of ICT loads includes a processor; and a memory storing instructions that cause the processor to execute a process. The process includes determining, using demand amounts of power demanded by ICT loads arranged at each base where a supply amount of power is available, as the optimum arrangement, an arrangement that minimizes, for the entire bases, costs incurred to purchase amounts of power exceeding the supply amount of power available at the base among the demand amounts of power demanded by the ICT loads when the ICT loads are arranged at the bases.

### TECHNICAL FIELD

The present disclosure relates to an optimum arrangement determination apparatus, an optimum arrangement determination method, and a program.

### BACKGROUND ART

In recent years, for the purpose of reducing the environmental load and the like, a movement to introduce renewable energy has been advanced worldwide. For this reason, operations using renewable energy are also in progress in data centers. On the other hand, renewable energy has large fluctuations in power generation output due to weather changes, etc., and there may be a surplus in the power supplied by renewable energy or, conversely, a power shortage. On the other hand, Non Patent Literature 1 discloses a method in which the arrangement of information and communication technology (ICT) loads is changed in a data center network in which renewable energy power generation equipment is installed, and power supplied by the renewable energy is effectively utilized in the entire data center network.

### CITATION LIST

### Non Patent Literature

Non Patent Literature 1: Ryota Nakamura, Shigeaki Harada, “Saisei kano enerugi o koryo shita ICT fuka haichi shuho no teian (in Japanese) (Proposal of ICT load arrangement method considering renewable energy)”, IEICE General Conference, B-14-4, March 2022.

### SUMMARY OF INVENTION

### Technical Problem

However, the method disclosed in Non Patent Literature 1 does not take into account the purchase of deficit power or the sale of surplus power after changing the arrangement of ICT loads. Therefore, for example, even if the deficit power in the entire data center network has been reduced by changing the arrangement of ICT loads, the cost incurred to purchase the deficit power may have increased.

The present disclosure has been made in view of the above points, and an object of the present disclosure is to provide a technology for determining an optimum load arrangement of renewable energy power in consideration of the buying and selling of surplus or deficit power.

### Solution to Problem

According to an aspect of the present disclosure, there is provided an optimum arrangement determination apparatus that determines an optimum arrangement of ICT loads that can be arranged at a plurality of bases constituting a target network, the optimum arrangement determination apparatus including: a pre-processing unit configured to offset demand amounts of power demanded by ICT loads arranged at each base where a supply amount of power generated by renewable energy is available with the supply amount of power; a main processing unit configured to determine, as the optimum arrangement, an arrangement that minimizes, for the entire plurality of bases, costs incurred to purchase amounts of power exceeding the supply amount of power available at the base among the demand amounts of power demanded by the ICT loads when the ICT loads are arranged at the bases, using the supply amount of power and the demand amount of power after the offset by the pre-processing unit; a post-processing unit configured to offset a demand amount of power of the optimally arranged ICT load determined by the main processing unit with the supply amount of power available at the base where the ICT load is arranged using the supply amount of power and the demand amount of power after the offset by the pre-processing unit; and an output unit configured to output the supply amount of power after the offset as an amount of power to be sold when all the demand amounts of power can be offset with the supply amount of power by the post-processing unit and the supply amount of power after the offset is larger than 0.

### Advantageous Effects of Invention

Provided is a technology for determining the optimum load arrangement for renewable energy power in consideration of the buying and selling of surplus or deficit power.

### BRIEF DESCRIPTION OF DRAWINGS

FIG. 1 is a diagram illustrating an example of a hardware configuration of an optimum arrangement determination apparatus according to an embodiment.

FIG. 2 is a diagram illustrating an example of a functional configuration of the optimum arrangement determination apparatus according to the present embodiment.

FIG. 3 is a flowchart illustrating an example of optimum arrangement determination processing according to the present embodiment.

FIG. 4 is a diagram for describing an example (part 1) of pre-processing.

FIG. 5 is a diagram for describing an example (part 2) of pre-processing.

FIG. 6 is a diagram for describing an example of main processing.

FIG. 7 is a diagram for describing an example of the influence of power purchase cost on main processing.

FIG. 8 is a diagram for describing an example of post-processing.

### DESCRIPTION OF EMBODIMENTS

An embodiment of the present invention will be described below. In the following embodiment, an optimum arrangement determination apparatus 10 capable of determining an optimum arrangement of ICT loads in the entire data center network in which renewable energy power generation equipment is installed in consideration of sale of surplus power and purchase of deficit power will be described.

Here, the data center network is a network including a data center (DC) in which an ICT load can be arranged, a node that transfers communication, and a link that connects them to each other. Further, under a node, there are a plurality of user terminals that utilize services provided by the data center network. Note that the data center network is assumed to be, for example, a wide-area network such as a countrywide core network.

Hereinafter, as an example, it is assumed that the ICT load is a virtual machine (VM), and at least one or more data centers in the data center network are equipped with solar cells as renewable energy power generation equipment. However, the ICT load is not limited to the virtual machine, and any ICT load can be employed as long as it can be arranged on the data center and the arrangement can be changed or moved. Further, renewable energy power generation equipment is not limited to solar cells, and may be other renewable energy power generation equipment (for example, wind power generation equipment, hydroelectric power generation equipment, geothermal power generation equipment, biomass power generation equipment, and the like).

Furthermore, the data center is also an example, and is not necessarily limited to the data center, and may be any facility as long as it is a base where the ICT load can be arranged.

### Preparation of Symbols

Several symbols used in the present embodiment will be prepared.

Assuming that there are a plurality of data centers in the data center network, a set of data centers j with power demand is referred to as A. A set of virtual machines (more accurately, a virtual machine arranged on a physical server in the data center j) in the data center j is referred to as V(j). Furthermore, a set of data centers j that are supplied with power by solar cells is referred to as B.

The demand amount of power of the virtual machine, the supply amount of power of the solar cell, and the power purchase cost per unit power of the data center j are expressed as follows.
aⱼₖ: Demand amount of power of virtual machine k∈ V(j) in data center j∈A
bⱼ: Supply amount of power by solar cell of data center j∈B
cⱼ: Power purchase cost per unit power of data center j∈A

Note that the data center in which the virtual machine is arranged can be dynamically changed at a predetermined certain time interval ΔT (for example, ΔT=30 minutes, 1 hour, or the like). Therefore, if a certain time is t, more accurately, A=A(t) and V(j)=V(t;j). Similarly, the demand amount of power, the supply amount of power, and the power purchase cost can also change depending on time t, and thus are more accurately expressed as aⱼₖ=aⱼₖ(t), bⱼ=bⱼ(t), and cⱼ=cⱼ(t). The renewable energy power generation equipment is not frequently installed (or removed), but considering the new installation or removal of the renewable energy power generation equipment, the data center to which solar cells supply power may also change depending on the time. Therefore, it can be similarly expressed as B=B(t). However, in the following description, a certain specific time is considered to be fixed, and the time t is not explicitly indicated in any case where misunderstanding is not an issue.

### <Example of Hardware Configuration of Optimum Arrangement Determination Apparatus 10>

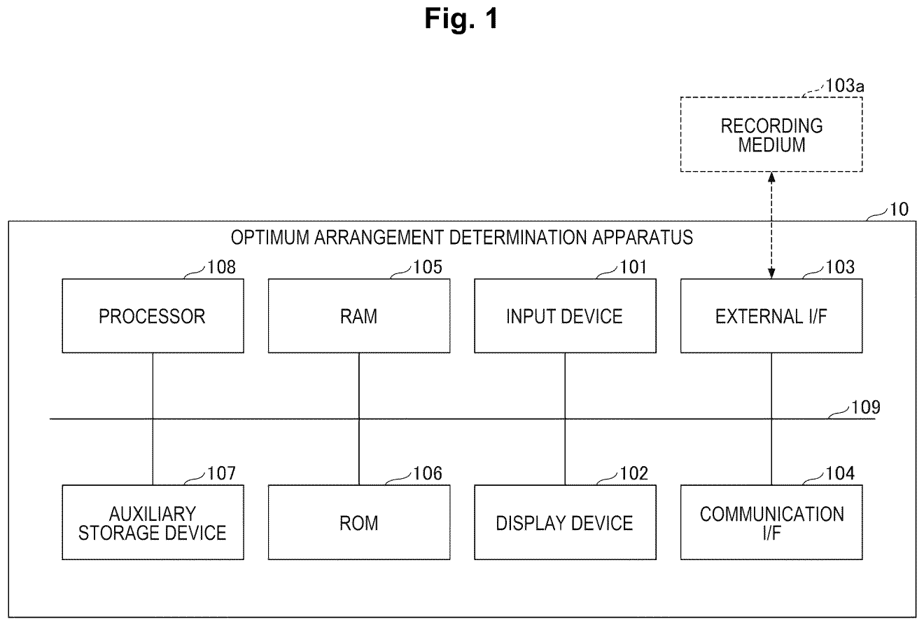

FIG. 1 illustrates an example of a hardware configuration of the optimum arrangement determination apparatus 10 according to the present embodiment. As illustrated in FIG. 1, the optimum arrangement determination apparatus 10 according to the present embodiment includes an input device 101, a display device 102, an external I/F 103, a communication I/F 104, a random access memory (RAM) 105, a read only memory (ROM) 106, an auxiliary storage device 107, and a processor 108. These hardware configurations are communicatively connected to each other via a bus 109.

The input device 101 is, for example, a keyboard, a mouse, a touch panel, a physical button, or the like. The display device 102 is, for example, a display, a display panel, or the like. The optimum arrangement determination apparatus 10 may not include, for example, at least one of the input device 101 and the display device 102.

The external I/F 103 is an interface with an external device such as a recording medium 103a. The optimum arrangement determination apparatus 10 can, for example, read from and write in the recording medium 103a via the external I/F 103. Examples of the recording medium 103a include a flexible disk, a compact disc (CD), a digital versatile disk (DVD), a secure digital memory card (SD memory card), a Universal Serial Bus (USB) memory card, and the like.

The communication I/F 104 is an interface for the optimum arrangement determination apparatus 10 to communicate with other apparatuses, devices, and the like. The RAM 105 is a volatile semiconductor memory (storage device) that temporarily holds programs and data. The ROM 106 is a non-volatile semiconductor memory (storage device) capable of holding programs and data even when power is turned off. The auxiliary storage device 107 is, for example, a storage device such as a hard disk drive (HDD), a solid state drive (SSD), or a flash memory. The processor 108 is, for example, an arithmetic device such as a central processing unit (CPU) or a graphics processing unit (GPU).

The optimum arrangement determination apparatus 10 according to the present embodiment can implement optimum arrangement determination processing to be described later by having the hardware configuration illustrated in FIG. 1. Note that the hardware configuration illustrated in FIG. 1 is an example, and the hardware configuration of the optimum arrangement determination apparatus 10 is not limited thereto. For example, the optimum arrangement determination apparatus 10 may include a plurality of auxiliary storage devices 107 and a plurality of processors 108, may not include a part of the illustrated hardware, or may include various types of hardware other than the illustrated hardware.

### <Example of Functional Configuration of Optimum Arrangement Determination Apparatus 10>

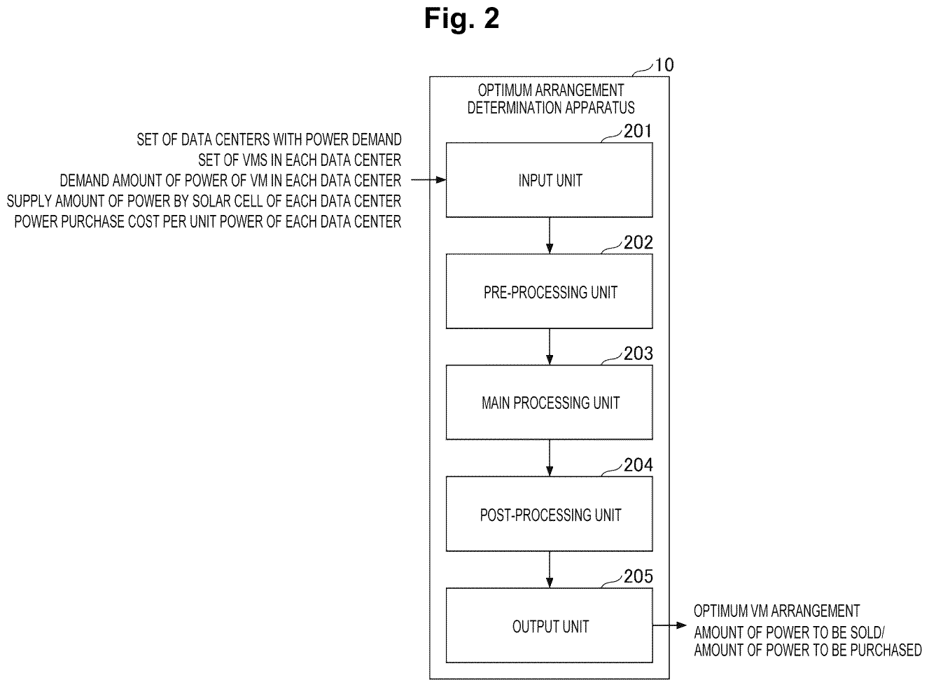

FIG. 2 illustrates an example of a functional configuration of the optimum arrangement determination apparatus 10 according to the present embodiment. As illustrated in FIG. 2, the optimum arrangement determination apparatus 10 according to the present embodiment includes an input unit 201, a pre-processing unit 202, a main processing unit 203, a post-processing unit 204, and an output unit 205. Each of these units is implemented, for example, by the process that one or more programs installed in the optimum arrangement determination apparatus 10 causes the processor 108 to execute.

The input unit 201 inputs information such as a set A of data centers with power demand, a set V(j) of virtual machines in each data center j∈A, a demand amount aⱼₖ of power of each virtual machine k∈V(j) in each data center j∈A, a supply amount bⱼ of power by a solar cell of each data center j, and a power purchase cost cⱼ per unit power of each data center j. Note that this information is generally collected and managed by an energy management system (EMS), a network management system (NMS), or the like that manages a data center network. Therefore, the input unit 201 may acquire and input this information from the EMS, the NMS, or the like, for example.

The pre-processing unit 202 subtracts the demand amount of power aⱼₖ of the virtual machine k∈V(j) from the supply amount bⱼ of power of the solar cell in each data center j∈A∩B, and offsets the supply amount bⱼ of power and the demand amount aⱼₖ of power as much as possible. Hereinafter, offsetting the supply amount bⱼ of power and the demand amount aⱼₖ of power will be referred to as power offset.

The main processing unit 203 uses the demand amount aⱼₖ of power and the supply amount bⱼ of power after the power offset to determine the arrangement of virtual machines that offset the supply amount bⱼ of power and the demand amount aⱼₖ of power as much as possible between the data centers. At this time, the main processing unit 203 reduces the problem to a multiple knapsack problem (see, for example, Reference Literature 1), and then calculates the optimum arrangement of the virtual machines (in other words, the optimal destinations of the virtual machines) as a solution to the problem. Hereinafter, the “optimum arrangement of virtual machines” obtained as a solution of the multiple knapsack problem will be referred to as an “optimum VM arrangement”.

The post-processing unit 204 offsets the supply amount bⱼ of power and the demand amount aⱼₖ of power in each data center j∈A∩B after the optimum VM arrangement, and calculates an amount of surplus power or an amount of deficit power when there is surplus power or deficit power. As a result of power offset, an amount of surplus power is obtained when the supply amount of power remains, and an amount of deficit power is obtained when the demand amount of power remains.

The output unit 205 outputs the optimum VM arrangement to a predetermined output destination determined in advance. In addition, the output unit 205 outputs the amount of surplus power to a predetermined output destination determined in advance as an amount of power to be sold when the amount of surplus power is obtained, and outputs the amount of deficit power to a predetermined output destination determined in advance as an amount of power to be purchased when the amount of deficit power is obtained. Here, examples of the output destination of the optimum VM arrangement include a virtual machine control device that controls the arrangement of the virtual machine. In addition, examples of the output destination of the amount of power to be sold and the amount of power to be purchased include a power control device that controls sale and purchase of power.

### <Optimum Arrangement Determination Processing>

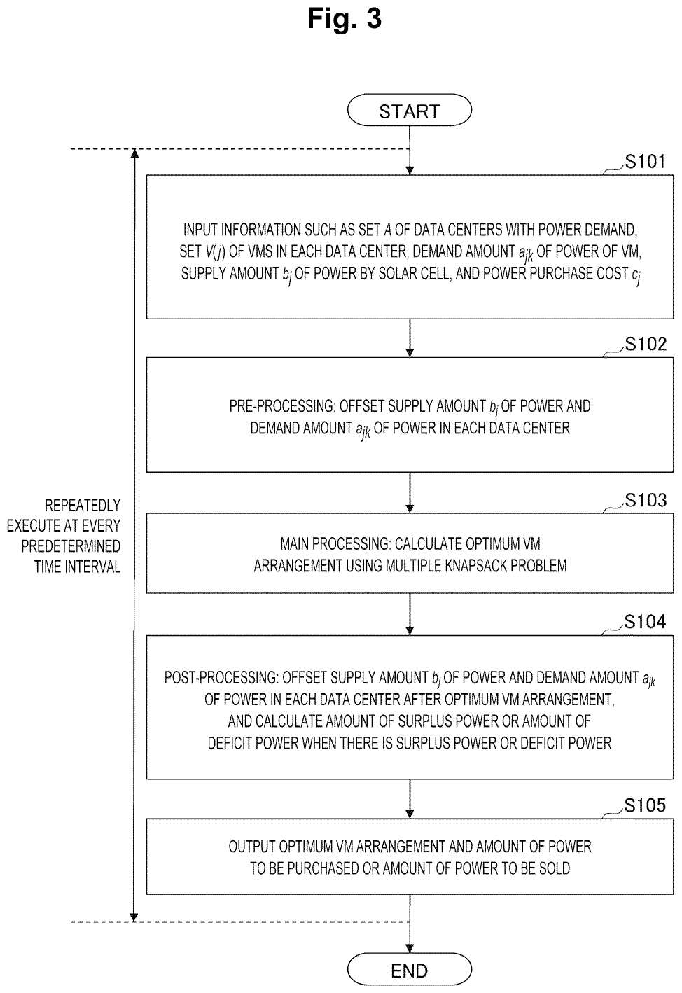

Optimum arrangement determination processing according to the present embodiment will be described below with reference to FIG. 3. Here, the following steps S101 to S105 are repeatedly executed, for example, at every predetermined certain time interval ΔT (for example, ΔT=30 minutes, 1 hour, or the like). Hereinafter, steps S101 to S105 at a certain time will be described.

The input unit 201 inputs information such as a set A of data centers with power demand, a set V(j) of virtual machines in each data center j∈A, a demand amount aⱼₖ of power of each virtual machine k∈V(j) in each data center j∈A, a supply amount bⱼ of power by a solar cell of each data center j, and a power purchase cost cⱼ per unit power of each data center j (step S101).

Next, the pre-processing unit 202 subtracts the demand amount aⱼₖ of power of the virtual machine k∈V(j) from the supply amount bⱼ of power of the solar cell in each data center j∈A∩B, and offsets the supply amount bⱼ of power and the demand amount aⱼₖ of power as much as possible (step S102). That is, the pre-processing unit 202 performs power offset for each data center j∈A∩B according to the following steps 1-1 to 1-2.

Step 1-1: Determine whether or not a_{jk′} that satisfies bⱼ≥a_{jk′} (k′∈V(j)) exists. When a_{jk′} that satisfies bⱼ≥a_{jk′} (k′∈V(j)) exists, step 1-2 is executed. On the other hand, when a_{jk′} that satisfies bⱼ≥a_{jk′} does not exist (that is, when bⱼ<aⱼₖ (∀k∈V(j)) or V(j)=φ holds), the power offset is ended.

Step 1-2: Set bⱼ←bⱼ-a_{jk′} and V(j)←V(j)\{k′} and return to step 1-1.

Note that there may be a plurality of a_{jk′}s that satisfy bⱼ≥a_{jk′} (k′∈V(j)) in step 1-1 above. Therefore, it is possible to variously determine which a a_{jk′} among the plurality of a_{jk′}s is to be subtracted from bⱼ in step 1-2 above. For example, as one idea, it is conceivable to subtract a_{jk′} having the largest value among a plurality of a_{jk′}s from bⱼ. This is an idea to preferentially offset power because it is difficult to change the arrangement of a virtual machine having a large demand amount of power. As another idea, for example, it is conceivable to evaluate the difficulty of changing the arrangement of the virtual machine from a positional or functional viewpoint and preferentially offset the power demand of the virtual machine having a high evaluation value. This is also an idea to preferentially offset the power demand of the virtual machine whose arrangement is difficult to change.

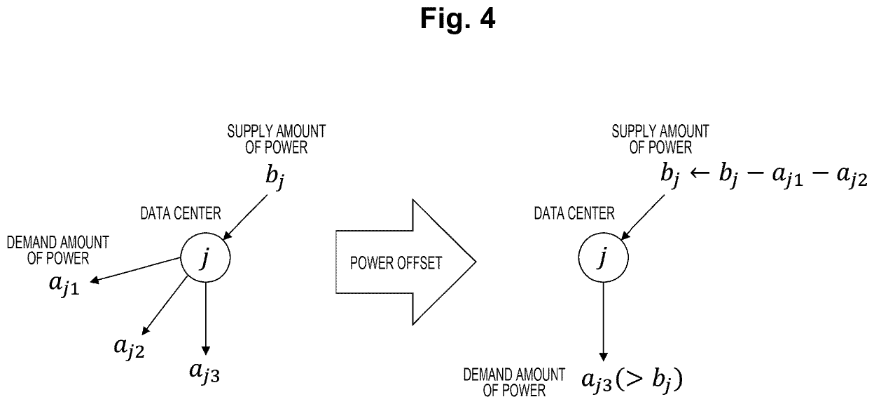

FIG. 4 illustrates an example of power offset in step S102 above. The example illustrated in FIG. 4 is an example of power offset in a certain data center j where the demand amounts aⱼ₁, aⱼ₂, and aⱼ₃ of power and the supply amount bⱼ of power exist. In this example, as a result of the power offset, the supply amount of power finally becomes bⱼ←bⱼ-aⱼ₁-aⱼ₂, and the demand amount aⱼ₃ (>bⱼ) of power remains.

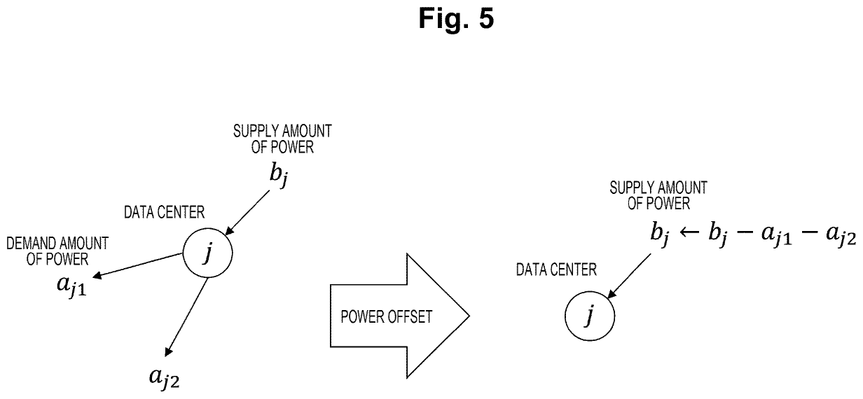

FIG. 5 illustrates another example of power offset in step S102 above. The example illustrated in FIG. 5 is an example of power offset in a certain data center j where the demand amounts aⱼ₁ and aⱼ₂ of power and the supply amount bⱼ of power exist. In this example, as a result of the power offset, the supply amount of power finally becomes bⱼ←bⱼ-aⱼ₁-aⱼ₂, and the demand amount of power does not remain.

Next, the main processing unit 203 uses the demand amount aⱼₖ of power and the supply amount bⱼ of power after the power offset in step S102 above to determine the optimum VM arrangement that offsets the supply amount bⱼ of power and the demand amount aⱼₖ of power as much as possible between the data centers (step S103). At this time, the main processing unit 203 reduces the problem to the multiple knapsack problem and then calculates the optimum VM arrangement as a solution to the problem.

A variable xᵢⱼₖ of the multiple knapsack problem is defined as follows.
xᵢⱼₖ: xᵢⱼₖ=1 if the virtual machine k∈V(j) is moved from the data center j∈A to the data center i∈A ∪B, otherwise xᵢⱼₖ=0

At this time, the multiple knapsack problem for optimizing the arrangement of the virtual machines is formulated as follows.

$$min {\sum }_{i ∈ A} {c}_{i} {\sum }_{k ∈ V ( i )} {a}_{i {k}^{x} i i k} \qquad [ Math . 1 ]$$

$$Subject to$$

$${\sum }_{í ∈ A ⋃ B} {x}_{i j k} = 1 ( i ∈ A , k ∈ V ( j ) ) ,$$

$${\sum }_{k ∈ V ( j )} {\sum }_{j ∈ A} {a}_{jk} {x}_{ijk} \leq {{b}_{i} ( i ∈ B )}_{,}$$

$${x}_{ijk} ∈ \{ 0 , 1 \} ( i ∈ A ⋃ B , j ∈ A , k ∈ V ( j ) )$$

However, it is assumed that the second constraint condition (inequality constraint) of the multiple knapsack problem shown in Expression 1 above is satisfied with a best effort (that is, it is allowed that it is not satisfied for some i∈B, for example).

The multiple knapsack problem shown in Expression 1 above represents that, for a virtual machine that has not been moved so that power can be supplied by solar cells, optimization is performed to cover its power demand through power purchase but to minimize the cost incurred for the power purchase.

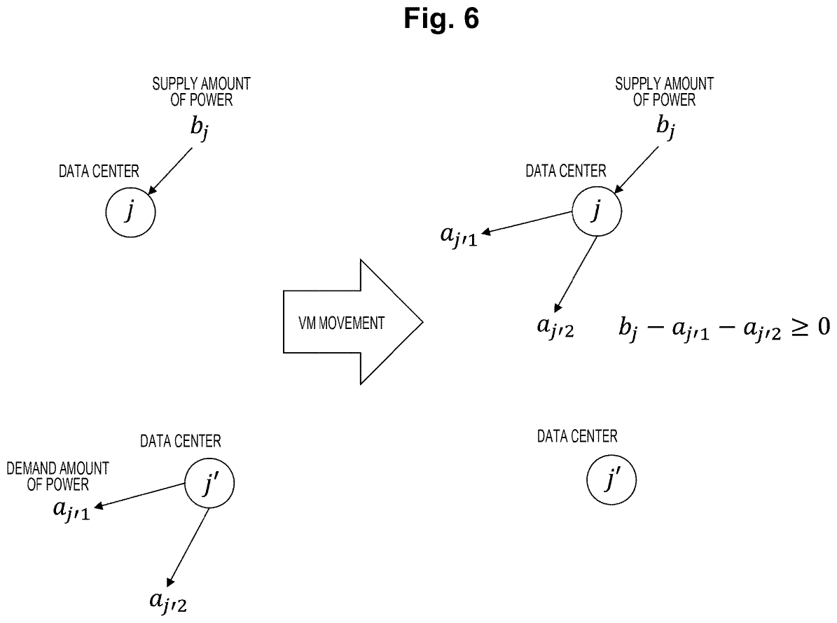

FIG. 6 illustrates an example of the optimum VM arrangement in step S103 above. The example illustrated in FIG. 6 illustrates a case where the supply amount bⱼ of power exists in a certain data center j, the demand amounts a_{j′1} and a_{j′2} of power exist in a certain data center j′, and a virtual machine corresponding to the demand amount a_{j′1} of power and a virtual machine corresponding to the demand amount a_{j′2} of power are moved (arranged) to the data center j. Note that bⱼ−a_{j′1}-a_{j′2}≥0 indicates that the second constraint condition of the multiple knapsack problem shown in Expression 1 above is satisfied.

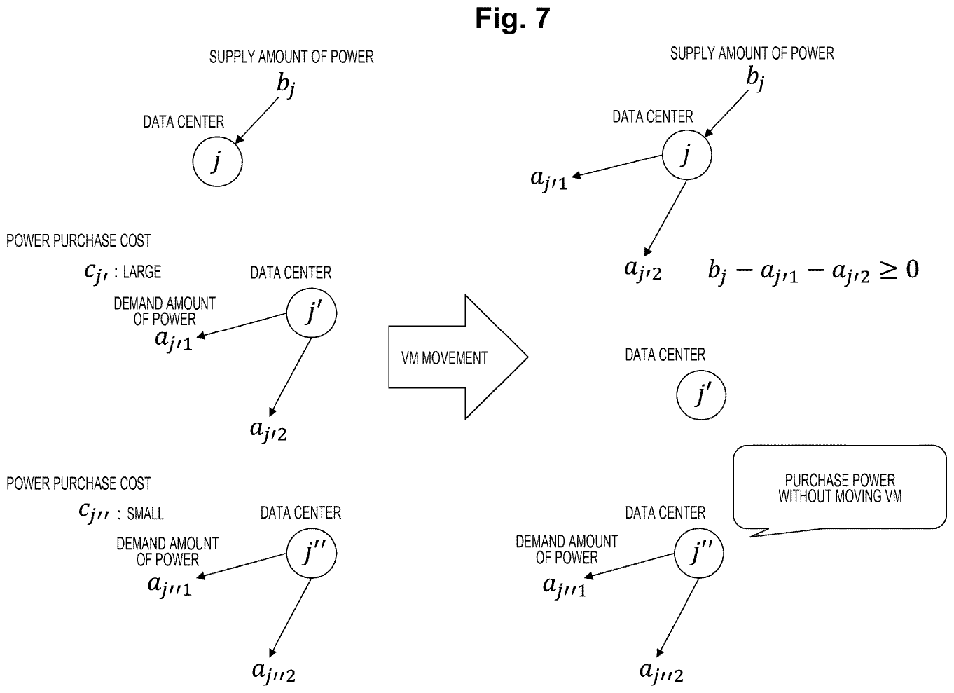

In the multiple knapsack problem shown in Expression 1 above, optimization is performed to minimize the cost incurred to purchase power to cover the demand amount of power of the virtual machine that has not been moved. Therefore, the optimum arrangement of the virtual machine is determined in consideration of the power purchase cost. For example, as illustrated in FIG. 7, it is assumed that the supply amount bⱼ of power exists in a certain data center j, the demand amounts a_{j′1}, and a_{j′2}, of power exist in a certain data center j′, and the demand amounts a_{j″1}, and a_{j″2} of power exist in a certain data center j″. At this time, when c_{j′}>c_{j″} (that is, when the power purchase cost of the data center j′ is greater than the power purchase cost of the data center j″), in order to minimize the total power purchase cost incurred to cover the demand amount of power of the unmoved virtual machine, the virtual machine corresponding to the demand amount a_{j′1} of power and the virtual machine corresponding to the demand amount a_{j′2} of power are preferentially moved.

Next, the post-processing unit 204 offsets the supply amount bⱼ of power and the demand amount aⱼₖ of power in each data center j∈A∩B after the optimum VM arrangement determined in step S103 above, and calculates an amount of surplus power or an amount of deficit power when there is surplus power or deficit power (step S104). That is, the post-processing unit 204 performs power offset and calculation of an amount of surplus power or an amount of deficit power for each data center j∈A∩B according to the following steps 2-1 to 2-4.

Step 2-1: Determine whether or not a_{jk′} that satisfies bⱼ≥a_{jk′} (k′∈V(j)) exists. Then, when a_{jk′} that satisfies bⱼ≥a_{jk′} (k′∈V(j)) exists, execute step 2-2. On the other hand, when a_{jk′} that satisfies bⱼ≥a_{jk′} does not exist (that is, when bⱼ<aⱼₖ (∀k∈V(j)) or V(j)=φ holds), execute step 2-3.

Step 2-2: Set bⱼ←bⱼ-a_{jk′} and V(j)←V(j)\{k′} and return to step 2-1.

Step 2-3: Determine whether or not bⱼ=0. Then, when bⱼ=0, since neither surplus power nor deficit power has occurred, end the processing. On the other hand, when bⱼ≠0, execute step 2-4.

Step 2-4: When aⱼₖ (>bⱼ) does not exist (that is, when V(j)=φ), set bⱼ as the amount of surplus power. On the other hand, when aⱼₖ (>bⱼ) exists (that is, when V(j)≠φ), set Σ_{k∈V(j)}aⱼₖ-bⱼ as the amount of deficit power.

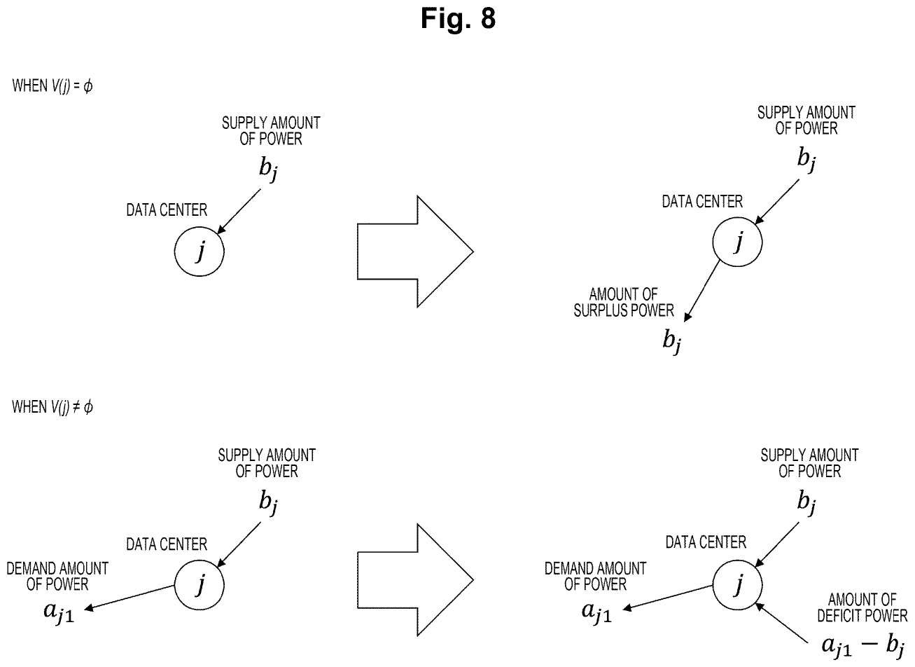

FIG. 8 illustrates an example of the calculation of the amount of surplus power and the amount of deficit power in step S104. In the example illustrated in FIG. 8, when V(j)=φ, the supply amount bⱼ of power is set as the amount of surplus power as it is, and when V(j)≠φ, a_{j1′}-bⱼ is set as the amount of deficit power. In the example illustrated in FIG. 8, it is assumed that V(j)={1} when V(j)≠φ.

Finally, the output unit 205 outputs the optimum VM arrangement determined in step S103 above to a predetermined output destination (for example, a virtual machine control device or the like), and when an amount of surplus power is obtained in a certain data center in step S104 above, the output unit 205 outputs the amount of surplus power as an amount of power to be sold, and when an amount of deficit power is obtained in a certain data center in step S104 above, the output unit 205 outputs the amount of deficit power as an amount of power to be purchased to a predetermined output destination (for example, a power control device or the like) (step S105). Accordingly, the arrangement of the virtual machines is changed to the optimum VM arrangement by the virtual machine control device or the like. In addition, when surplus power or deficit power occurs in a certain data center, surplus power is sold and deficit power is purchased by a power control device or the like.

### Conclusion

As described above, the optimum arrangement determination apparatus 10 according to the present embodiment determines an optimum arrangement of virtual machines through three stages of pre-processing, main processing, and post-processing. With this, in consideration of the supply and demand balance of power, it is possible to cover the power demand of as many virtual machines as possible by the power supply by the solar cell and to minimize the cost incurred for power purchase. On the other hand, when the supply amount of power by the solar cell is excessive after the power demand of the virtual machine is not covered, the surplus can be set as the amount of power to be sold.

Therefore, even when the amount of power supplied by renewable energy fluctuates due to weather changes or the like, the amount of power supplied can be used efficiently and effectively. That is, since the demand amount of power of the ICT load is covered as much as possible with the amount of power supplied by the renewable energy so that the total power purchase cost for the shortage is minimized through the above three-stage processing, the amount of power supplied can be efficiently used. In addition, even when a surplus occurs in the amount of power supplied by the renewable energy, the surplus can be used as the amount of power to be sold, and therefore the surplus can be effectively utilized.

The present invention is not limited to the above-mentioned specifically disclosed embodiment, and various modifications and changes, combinations with known technique, and the like can be made without departing from the scope of the claims.

### REFERENCE LITERATURE

Reference Literature 1: Applied Mathematical Planning Handbook, Mikio Kubo et al., Asakura Shoten, 2002, p240-241.

### REFERENCE SIGNS LIST

10 Optimum arrangement determination apparatus
101 Input device
102 Display device
103 External I/F
103a Recording medium
104 Communication I/F
105 RAM
106 ROM
107 Auxiliary storage device
108 Processor
109 Bus
201 Input unit
202 Pre-processing unit
203 Main processing unit
204 Post-processing unit
205 Output unit

1. An apparatus for determining an optimum arrangement of ICT loads, the apparatus comprising:
a processor; and
a memory storing instructions that cause the processor to execute a process, the process including
determining, using demand amounts of power demanded by ICT loads arranged at each base where a supply amount of power is available, as the optimum arrangement, an arrangement that minimizes, for the entire bases, costs incurred to purchase amounts of power exceeding the supply amount of power available at the base among the demand amounts of power demanded by the ICT loads when the ICT loads are arranged at the bases.

2. The apparatus according to claim 1, wherein the process further includes
offsetting demand amounts of power demanded by ICT loads arranged at each base where a supply amount of power is available with the supply amount of power;
offsetting all the demand amounts of power of the ICT loads after the optimum arrangement with the supply amount of power available at the base where the ICT load is arranged using the supply amount of power and the demand amount of power after the offsetting; and
offsetting the supply amount of power after the offsetting as of an amount of power to be sold when the supply amount of power after the offsetting is larger than a predetermined value, and outputting the demand amount of power after the offsetting as an amount of power to be purchased when the demand amount of power after the offsetting is larger than the predetermined value.

3. The apparatus according to claim 2, wherein the process further includes outputting, when at least some of the demand amounts of power have failed to be offset with the supply amount of power, an amount of power obtained by subtracting the supply amount of power after the offsetting from the demand amounts of power that have failed to be offset as an amount of power to be purchased.

4. The apparatus according to claim 1, wherein the process further includes
formulating a problem for obtaining the optimum arrangement as a multiple knapsack problem; and
determining the optimum arrangement by solving the multiple knapsack problem.

5. The apparatus according to claim 4, wherein
the process further includes formulating, with respect to the ICT loads whose arrangement has not been changed, the multiple knapsack problem as a problem of minimizing a sum of costs incurred to purchase amounts of power exceeding the supply amount of power available at the bases at which the ICT loads are arranged, among the demand amounts of power demanded by the ICT loads, and wherein
the multiple knapsack problem includes a first constraint condition indicating that each ICT load is arranged at any one base, and a second constraint condition indicating that a total of the demand amounts of power demanded by the ICT loads arranged at each base is equal to or less than the supply amount of power available at the base.

6. The apparatus according to claim 5, wherein the second constraint condition is a constraint condition to be satisfied with a best effort.

7. A method executed by an apparatus for determining an optimum arrangement of ICT loads, the method comprising:
determining, using demand amounts of power demanded by ICT loads arranged at each base where a supply amount of power is available, as the optimum arrangement, an arrangement that minimizes, for the entire bases, costs incurred to purchase amounts of power exceeding the supply amount of power available at the base among the demand amounts of power demanded by the ICT loads when the ICT loads are arranged at the bases.

8. A non-transitory computer-readable recording medium having computer-readable instructions stored thereon, which when executed, cause an apparatus for determining an optimum arrangement of ICT loads to execute the method according to claim 7.

9. An optimum arrangement determination apparatus that determines an optimum arrangement of ICT loads, the ICT loads being arranged at a plurality of bases constituting a target network, the optimum arrangement determination apparatus comprising:
a processor, and
a memory storing instructions that cause the processor to execute a process, the process including
offsetting demand amounts of power demanded by ICT loads arranged at each base where a supply amount of power generated by renewable energy is available with the supply amount of power,
determining, as the optimum arrangement, an arrangement that minimizes, for the entire plurality of bases, costs incurred to purchase amounts of power exceeding the supply amount of power available at the base among the demand amounts of power demanded by the ICT loads when the ICT loads are arranged at the bases, using the supply amount of power and the demand amount of power after the offsetting;
offsetting a demand amount of power of the determined optimally arranged ICT load with the supply amount of power available at the base where the ICT load is arranged using the supply amount of power and the demand amount of power after the offsetting; and
outputting the supply amount of power after the offsetting as an amount of power to be sold when all the demand amounts of power can be offset with the supply amount of power and the supply amount of power after the offsetting is larger than a predetermined value.

10. The optimum arrangement determination apparatus according to claim 9, wherein
the process further includes outputting, when at least some of the demand amounts of power has been failed to offset with the supply amount of power, an amount of power obtained by subtracting the supply amount of power after the offsetting from the demand amounts of power that have failed to be offset as an amount of power to be purchased.

11. The optimum arrangement determination apparatus according to claim 9, wherein
the process further includes determining the optimum arrangement by formulating a problem for obtaining the optimum arrangement as a multiple knapsack problem and solving the multiple knapsack problem.

12. The optimum arrangement determination apparatus according to claim 11, wherein
the process further includes formulating, with respect to the ICT loads whose arrangement has not been changed, the multiple knapsack problem as a problem of minimizing a sum of costs incurred to purchase amounts of power exceeding the supply amount of power available at the bases at which the ICT loads are arranged, among the demand amounts of power demanded by the ICT loads, and wherein
the multiple knapsack problem includes a first constraint condition indicating that each ICT load is arranged at any one base, and a second constraint condition indicating that a total of the demand amounts of power demanded by the ICT loads arranged at each base is equal to or less than the supply amount of power available at the base.

13. The optimum arrangement determination apparatus according to claim 12, wherein the second constraint condition is a constraint condition to be satisfied with a best effort.
